(19) United States
(12) Patent Application Publication
(10) Pub. No.: US 2008/0116798 A1
(43) Pub. Date: May 22, 2008

(54) PLASMA DISPLAY PANEL

(75) Inventor: Sang-Hyun KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/872,977

(22) Filed: Oct. 16, 2007

(30) Foreign Application Priority Data
Nov. 21, 2006 (KR) 10-2006-0115224

(51) Int. Cl. H01J 17/49

(52) U.S. Cl. 313/582

(57) ABSTRACT

A plasma display panel is provided that reduces reflective brightness and increases the black area. The plasma display panel includes: a front substrate and a rear substrate facing each other at a distance; an address electrode which is formed on the rear substrate and extends in a first direction; a display electrode which is formed on the front substrate and extends in a second direction crossing the first direction; a barrier rib which is disposed between the front and rear substrates to define a plurality of discharge cells; and a phosphor layer which is formed on each of the discharge cells, wherein the display electrode comprises: a transparent electrode which has a curved portion on a second surface that is an opposite surface of a first surface facing the front substrate; and a bus electrode which is attached to the second surface of the transparent electrode where the curved portion is formed.

### CROSS-REFERENCE TO RELATED APPLICATIONS

This application claims the benefit of Korean Application No. 2006-115224, filed Nov. 21, 2006 in the Korean Intellectual Property Office, the disclosure of which is incorporated herein by reference.

### BACKGROUND OF THE INVENTION

1. Field of the Invention

Aspects of the present invention relate to a plasma display panel, and more particularly, to a plasma display panel that reduces reflective brightness and increases the black area.

2. Description of the Related Art

A plasma display panel generates plasma by using a discharge phenomenon. An ultraviolet (UV) ray is irradiated from the plasma. The UV excites a phosphor layer. The phosphor layer generates red (R), green (G), and blue (B) visible light beams. The visible light beams are combined to form an image.

With a plasma display panel having this structure, a large screen display can easily be designed and manufactured. Further, since a plasma display panel is a self-emitting display element, for example a cathode ray tube (CRT), a plasma display panel provides not only a color reproduction capability but also a wide viewing angle, resulting in an excellent image display capability. Furthermore, a plasma display panel can be manufactured in a simpler process than the process for manufacturing a liquid crystal display (LCD). Therefore, there are advantages in terms of productivity and cost to a plasma display panel over an LCD.

A typical AC-type plasma display panel has a structure in which address electrodes are formed on a rear substrate, and a dielectric layer covers the address electrodes. Further, a barrier rib is formed in a grid shape on the dielectric layer so as to define discharge cells. Phosphor layers are formed on the inner surfaces of the discharge cells. Display electrodes are formed on one surface of a front substrate, which is spaced apart from the rear substrate at a distance. The display electrodes extend orthogonally in the direction crossing the address electrodes.

If the external environment is bright, for example, a bright room condition, the contrast of the plasma display panel is lowered. As a result, the image display capability of the plasma display panel also is lower. Various attempts have been made to improve the image display capability of the plasma display panel. There are methods in which the bright room contrast is increased by increasing the black area and reducing reflective brightness and methods in which brightness is improved by increasing emission efficiency.

### SUMMARY OF THE INVENTION

Aspects of the present invention solve the above-mentioned and/or other problems by providing a plasma display panel in which the structure of a display electrode (or front substrate) is improved so that the adhesive force between a bus electrode and the display electrode (i.e., the front substrate) is enhanced while increasing the black area and increasing the bright room contrast.

An aspect of the present invention provides a plasma display panel comprising: a front substrate and a rear substrate facing each other at a distance; an address electrode which is formed on the rear substrate and extends in a first direction; a display electrode which is formed on the front substrate and extends in a second direction crossing the first direction; a barrier rib which is disposed between the front and rear substrates to define a plurality of discharge cells; and a phosphor layer which is formed on each of the discharge cells. The display electrode comprises: a transparent electrode which has a curved portion on a second surface that is an opposite surface to the first surface facing the front substrate; and a bus electrode which is attached to the second surface of the transparent electrode where the curved portion is formed.

In the aforementioned aspect of the present invention, the bus electrode may comprise: a black layer in contact with the second surface of the transparent electrode; and a white layer formed on the black layer. Further, the black layer may include one or more metals selected from the group consisting of ruthenium (Ru), cobalt (Co), and manganese (Mn). Further, the white layer may include one or more metals selected from the group consisting of silver (Ag), gold (Au), and aluminum (Al).

In addition, the curved portion of the transparent electrode may be formed as a depression in the electrode, and that depression may have a hemispheric cross-section. Further, the depressed portion may be constructed with a plurality of long channels adjacent to one another in one direction, and a part of the bus electrode may be inserted into the depressed portion. In addition, the curved portion of the transparent electrode may be formed in the shape of a protrusion.

Another aspect of the present invention provides a plasma display panel comprising a bus electrode which is formed along a region where the depressions are formed on the surface of the front substrate that faces the rear substrate at a distance and in which the depressions are formed on the surface thereof facing the rear substrate.

In the aforementioned aspect of the present invention, the bus electrode may comprise: a black layer in contact with the surface where the depressions of the front substrate are formed; and a white layer formed on the black layer. In addition, the plasma display panel may further comprise a colored layer which is formed along the region where the depressions are formed and is spaced apart from the bus electrode.

The plasma display panel of this aspect of the present invention, and the actual surface area of the black layer are large, wherein the black layer is formed along the depressions or protrusions formed on the transparent electrode. Thus, there is an advantage in that the black area of the panel increases, whereas the reflective brightness decreases.

In addition, the actual surface area of a black layer is large, wherein the black layer is formed along the depressions or protrusions formed on the front substrate. Therefore, there is an advantage in that the black area of the panel increases, whereas the reflective brightness decreases.

In addition, the actual surface area of the colored layer is large, wherein the colored layer is formed along the depressions or protrusions formed on the front substrate. Therefore, there is an advantage in that the black area of the panel increases, whereas the reflective brightness decreases.

In addition, since a bus electrode is formed along the depressions or protrusions formed on the transparent electrode, there is an advantage in that the assembled structure between the transparent electrode and the bus electrode can be strengthened.

In addition, since a bus electrode (or a colored layer) is formed along depressions or protrusions formed on the front substrate, there is an advantage in that the assembled structure between the front substrate and the bus electrode (or the colored layer) can be strengthened.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial perspective view of a plasma display panel according to a first embodiment of the present invention;

FIG. 2 is a cross-sectional view of the plasma display panel taken along line II-II of FIG. 1;

FIG. 3 is a detailed view of portion A of FIG. 2;

FIG. 4 is a partial perspective view illustrating a transparent electrode of the plasma display panel according to the first embodiment of the present invention;

FIG. 5 is a plan view schematically illustrating an image display area of the plasma display panel according to the first embodiment of the present invention;

FIG. 6 is a partial perspective view illustrating a transparent electrode of the plasma display panel according to a second embodiment of the present invention;

FIG. 7 is a partial perspective view of the transparent electrode of the plasma display panel according to a third embodiment of the present invention;

FIG. 8 is a partial perspective view of the transparent electrode of the plasma display panel according to a fourth embodiment of the present invention;

FIG. 9 is a partial perspective view of the transparent electrode of the plasma display panel according to a fifth embodiment of the present invention;

FIG. 10 is a partial cross-sectional view of the plasma display panel according to a sixth embodiment of the present invention; and

FIGS. 11A to 11D are plan views illustrating various patterns of depressions formed on the front substrate of the plasma display panel according to a sixth embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

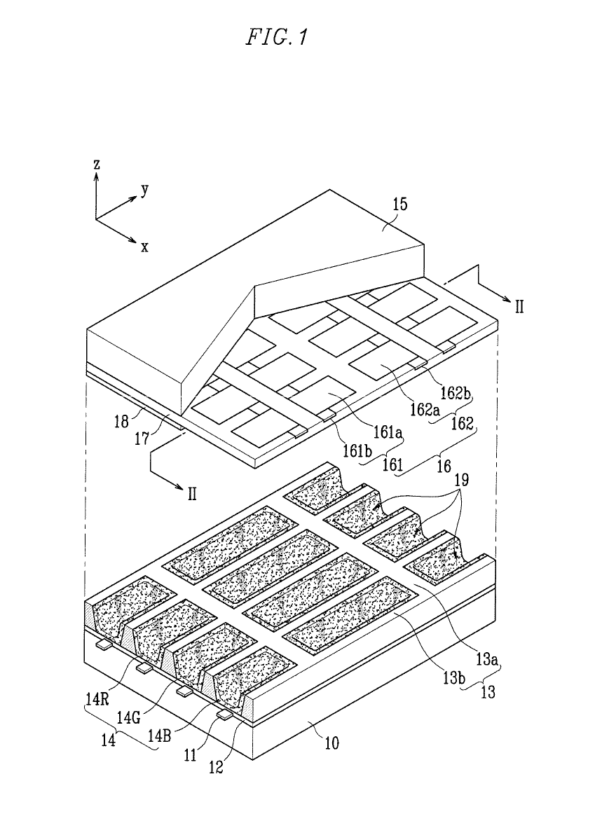

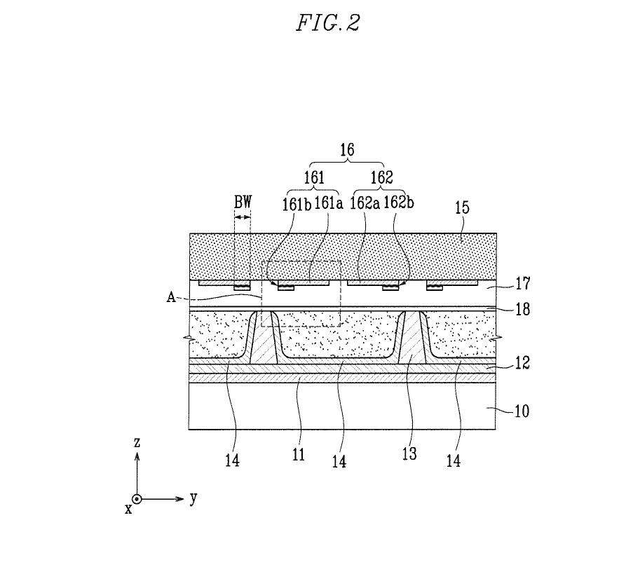

FIG. 1 is a partial perspective view of a plasma display panel according to a first embodiment of the present invention. FIG. 2 is a cross-sectional view of the plasma display panel taken along line II-II of FIG. 1.

Referring to the drawings, the plasma display panel includes a rear substrate 10, an address electrode 11, a rear dielectric layer 12, a barrier rib 13, and a phosphor layer 14. Further, the plasma display panel includes a front dielectric layer 17, a display electrode 16, and a protective layer 18.

The rear substrate 10 and the front substrate 15 face each other at a distance. The address electrode 11 extends in a second direction (y-axis direction in the drawing) on the upper surface of the rear substrate 10. Address electrodes 11 are formed in parallel with each other with distances between them. Further, the rear dielectric layer 12 is formed on the upper surface of the rear substrate 10. The rear dielectric layer 12 covers the address electrode 11.

The display electrode 16 extends in a second direction (x-axis direction in the drawing) on the lower surface of the front substrate 15. Adjacent display electrodes 16 are formed in parallel with each other with distances between them.

As shown in the drawings, the display electrode 16 includes a sustain electrode 161 and a scan electrode 162. The sustain electrode 161 and the scan electrode 162 respectively include transparent electrodes 161a and 162a and bus electrodes 161b and 162b. The bus electrodes 161b and 162b are formed on the lower surface of the transparent electrodes 161a and 162a. The transparent electrodes 161a and 162a are spaced apart from each other so as to form a discharge gap.

The transparent electrodes 161a and 162a are made of a transparent material such as indium tin oxide (ITO), thereby easily transmitting visible light. However, the conductivity of the transparent material is poor due to its high electrical resistance. On the other hand, the bus electrodes 161b and 162b are made of a metal material having a good conductivity such as silver (Ag), so that voltage can be easily supplied to the transparent electrodes 161a and 162a.

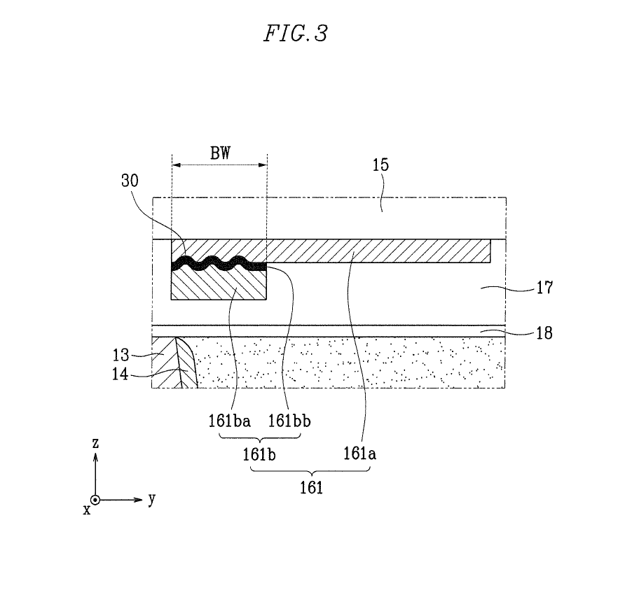

When widths BW of the bus electrodes 161b and 162b increase, the black area increases, whereas the reflective brightness decreases. However, when that is done, visible light generated from the discharge cells 19 is blocked, and that leads to a reduction in emission efficiency. In order to solve the problem, in this embodiment of the present invention, the black area is increased by altering the structures of the bus electrodes 161b and 162b, and the reflective brightness is therefore decreased. Details of this alteration will be further described later with reference to FIG. 3.

The front dielectric layer 17 is formed on the lower surface of the front substrate 15. The front dielectric layer 17 covers the display electrode 16. Thus, the front dielectric layer 17 protects the display electrodes 16 against a discharge phenomenon. Further, the front dielectric layer 17 accumulates wall charges to produce a discharge.

The front dielectric layer 17 is covered with a protective layer 18. The protective layer 18 is made of a transparent material. Thus, the protective layer 18 not only easily transmits visible light emitted from the phosphor layer 14, but also protects the front dielectric layer 17 against the discharge phenomenon. Further, the protective layer 18 serves to decrease the discharge ignition voltage by increasing the secondary electron emission coefficient.

As shown in FIGS. 1 and 2, the barrier rib 13 is formed between the protective layer 18 and the rear dielectric layer 12. The barrier rib 13 includes a horizontal barrier member 13a and a vertical barrier member 13b. That is, the horizontal barrier member 13a extends in the second direction (x-axis direction in the drawing). The vertical barrier member 13b extends in the first direction (y-axis direction in the drawing). The horizontal barrier member 13a crosses the vertical barrier member 13b. In this embodiment of the present invention, the horizontal and vertical barrier members 13a and 13b define the discharge cells 19 in a rectangular grid.

The discharge cells 19 according to this embodiment of the present invention may be formed in various shapes such as rectangular or triangular. In whatever shape, the barrier rib 13 prevents cross-talk between the discharge cells 19 and provides a surface on which the phosphor layer 14 is applied.

A discharge gas that is inert (e.g., a mixture of Ne and Xe) fills the discharge cells 19. The discharge gas generates a gas discharge between the sustain electrode 161 and the scan electrode 162. Visible light beams are generated from the phosphor layer 14 by the gas discharge. The visible light beams are combined to form an image.

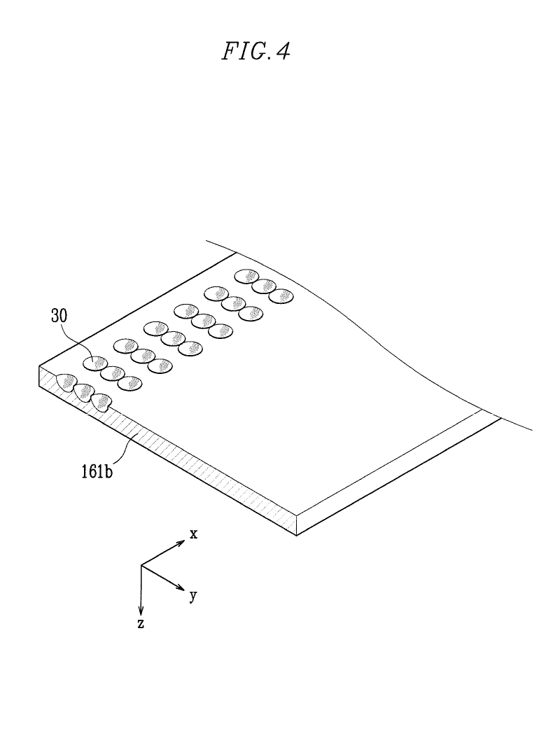

FIG. 3 is a detailed view of a portion A of FIG. 2, and FIG. 4 is a partial perspective view illustrating the transparent electrode of the plasma display panel according to the first embodiment of the present invention.

Referring to FIG. 3, the bus electrode 161b is formed below the transparent electrode 161a. The bus electrode 161b has a width BW. Further, the bus electrode 161b includes a black layer 161bb and a white layer 161ba. The black layer 161bb comes in contact with the transparent electrode 161a. The white layer 161ba is formed on the lower surface of the black layer 161bb.

The black layer 161bb has a dark color close to black. The dark color easily absorbs light. Therefore, light externally irradiated toward the plasma display panel can be absorbed so as to reduce the reflective brightness and to increase the black area. Accordingly, the bright room contrast is improved.

Depressions 30 are formed on the lower surface of the transparent electrode 161a (see FIG. 4). The black layer 161bb is formed along the depressions 30. In other words, the depressions 30 are formed on the lower surface of the transparent electrode 161a that is in contact with the bus electrode 161b. In particular, a part of the black layer 161bb is inserted into the depressions 30 of the transparent electrode 161a. Accordingly, the adhesive force between the transparent electrode 161a and the bus electrode 161b can be further enhanced.

In addition, since the black layer 161bb is formed along the depressions 30 of the transparent electrode 161a, there is an advantage in that the actual surface area of the black layer 161bb increases. As a result, the black layer 161bb appears even darker, thereby increasing the black area of the panel. Therefore, the light-absorption ratio for externally irradiated light increases, resulting in a decrease in the reflective brightness of the panel.

The black layer 161bb contains ruthenium (Ru), cobalt (Co), or manganese (Mn). Hence, the black layer 161bb has a dark color, i.e., close to black, and the conductivity of the black layer 161bb is low. On the other hand, the white layer 161ba contains silver (Ag), gold (Au), or aluminum (Al). Hence, the white layer 161ba has a bright color, i.e., close to white, and the conductivity of the white layer 161ba is excellent.

Referring to FIG., the depressions 30 are formed on the transparent electrode 161a. The depressions 30 have a hemispheric shape and are arranged in the first direction (y-axis direction in the drawing) and the second direction (x-axis direction in the drawing), spaced apart from one another at a distance.

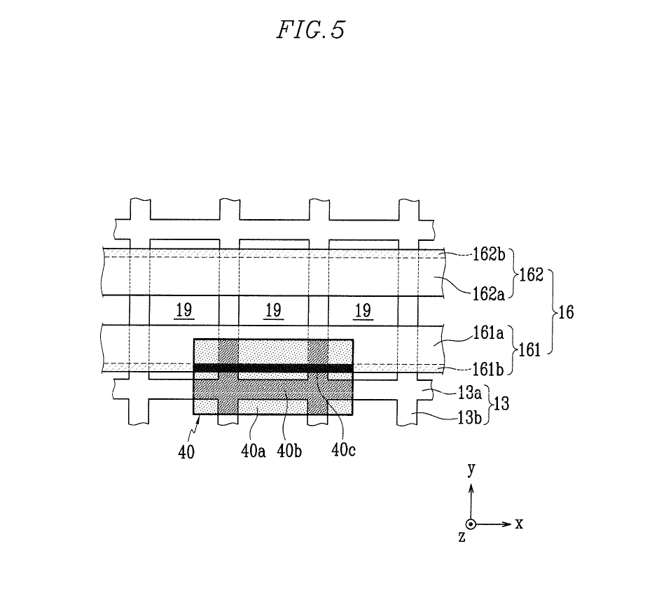

FIG. 5 is a plan view schematically illustrating an image display area of the plasma display panel according to the first embodiment of the present invention. Referring to FIG. 5, the discharge cells 19 are defined by the barrier rib 13. The sustain electrode 161 and the scan electrode 162 are formed in a pair and extend in the second direction (x-axis direction in the drawing) along the discharge cells 19. The bus electrodes 161b and 162b are linearly formed on the lower surfaces of the transparent electrodes 161a and 162a. As described with reference to FIG. 3, the bus electrode 161b includes the black layer 161bb and the white layer 161ba.

As shown in FIG. 5, the plasma display panel has an image display area 40. For convenience, only a part of the image display area 40 is depicted. The image display area 40 includes a first area 40a, a second area 40b, and a third area 40c. The first area 40a is an area in which the phosphor layer 14 is visible through the front substrate 15. The second area 40b is an area in which the barrier rib 13 is visible through the front substrate 15. The third area 40c is an area in which the bus electrodes 161b and 162b are visible through the front substrate 15. In this embodiment of the present invention, the third area 40c has a black color due to the black layer 161bb (shown in FIG. 3). That is, the actual surface area of the black layer 161bb increases, thereby increasing the black area and the external light absorption ratio.

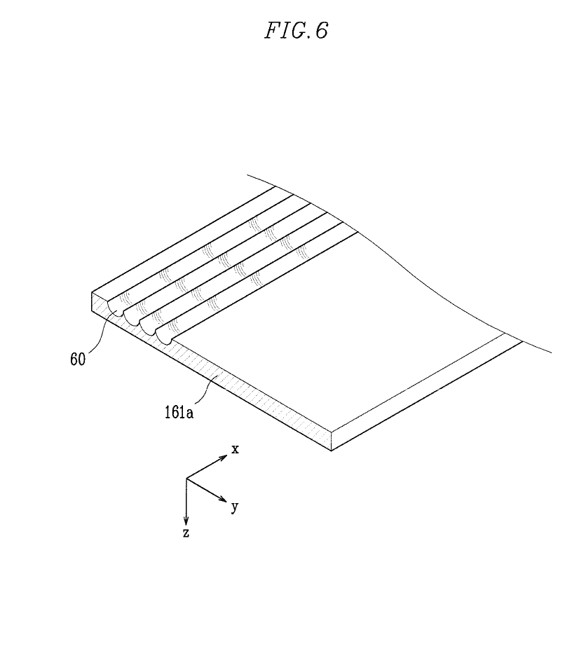

FIG. 6 is a partial perspective view illustrating the transparent electrode of the plasma display panel according to a second embodiment of the present invention. Referring to FIG. 6, depressions 60 are formed in the transparent electrode 161a. The depressions 60 are formed in the shape of channels extending in a second direction (x-axis direction in the drawing). The depressions 60 are arranged in a first direction (y-axis direction in the drawing). Specifically, the channels formed in the depressions 60 have a concave shape in which a plurality of the channels are adjacent to one another in that first (y-axis) direction.

FIG. 7 is a partial perspective view of the transparent electrode of the plasma display panel according to a third embodiment of the present invention. Referring to FIG. 7, depressions 70 are formed in the shape of channels extending in a first direction (y-axis direction in the drawing) and are arranged in a second direction (x-axis direction in the drawing). Specifically, the channels formed in the depressions 70 have a concave shape in which a plurality of the channels are adjacent to one another in that second (x-axis) direction.

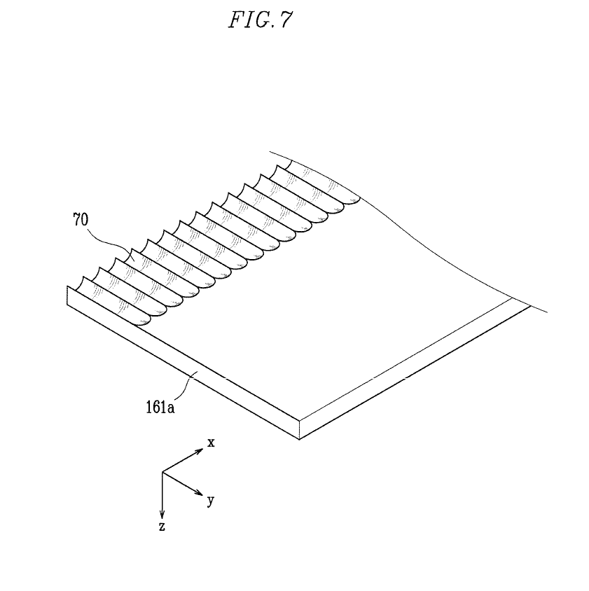

FIG. 8 is a partial perspective view of the transparent electrode of the plasma display panel according to a fourth embodiment of the present invention. Referring to FIG. 8, protrusions 80 are formed on a surface of the transparent electrode 161a. The bus electrode 161b and the black layer 161bb are formed along the protrusion 80. Although the protrusions 80 have a hemispheric shape in this embodiment of the present invention, the protrusions 80 may have another shape such as a pyramid shape or a cuboid shape.

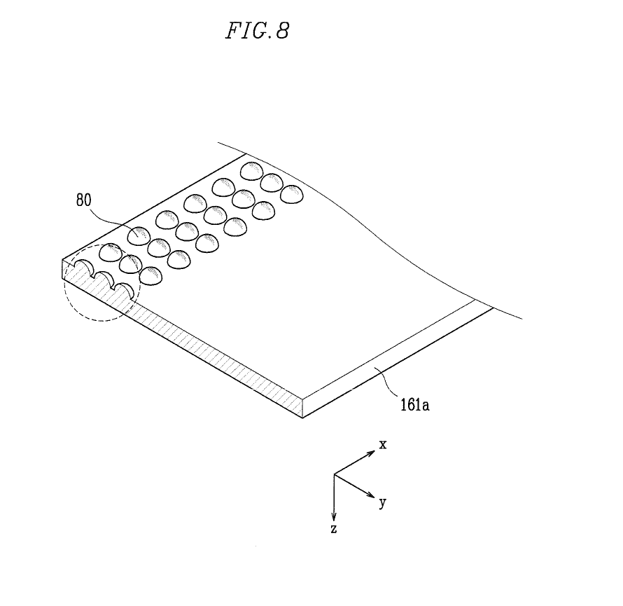

FIG. 9 is a partial perspective view of the transparent electrode of the plasma display panel according to a fifth embodiment of the present invention. Referring to FIG. 9, depressions 90 are formed in the transparent electrode 161a. The depressions 90 are arranged in a zigzag shape.

In several embodiments of the present invention, the protrusion portions 80 (FIG. 8) or the depressions 30 (FIG. 4), 60 (FIG. 6), and 90 (FIG. 9) may be formed on the transparent electrodes 161a and 162a. With the resulting increase in contact area between the black layer 161bb and the transparent electrodes 161a and 162, there is an advantage in that an assembled structure of the transparent electrode and the bus electrode is strengthened.

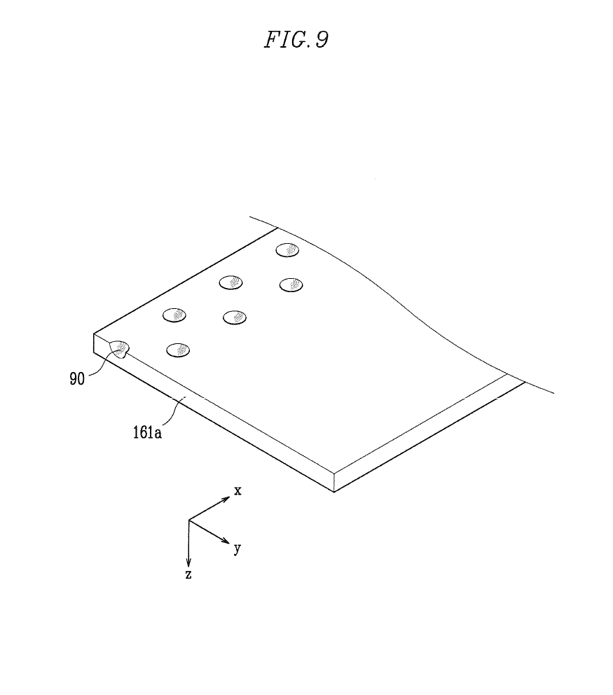

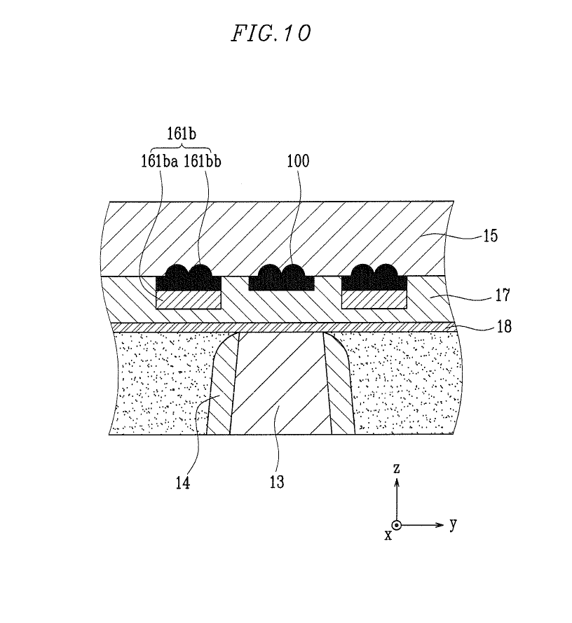

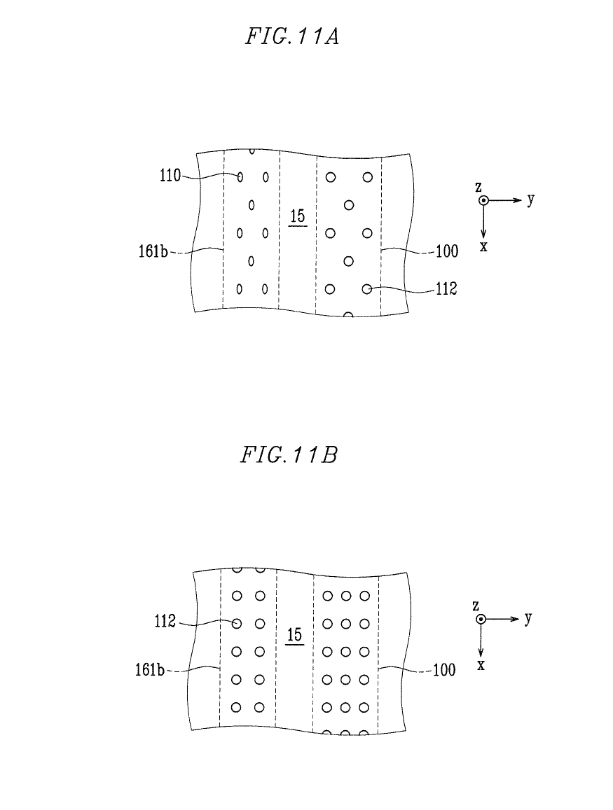

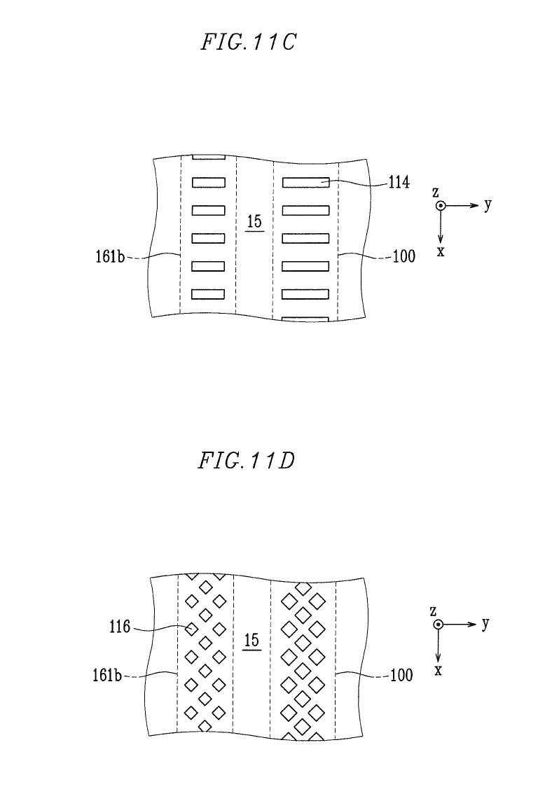

FIG. 10 is a partial cross-sectional view of the plasma display panel according to a sixth embodiment of the present invention. FIGS. 11A to 11D are plan views illustrating various patterns of depressions formed in the front substrate of the plasma display panel according to the sixth embodiment of the present invention. Descriptions will be given with reference to FIG. 10 and FIGS. 11A to 11D according to the sixth embodiment of the present invention. The same or like parts of FIGS. 1 to 9 will be referenced with the same reference numerals. The descriptions thereof will be omitted.

Referring to FIG. 10, the bus electrode 161b and a colored layer 100 are formed on the lower surface of the front substrate 15. As described above, the bus electrode 161b includes the black layer 161bb and the white layer 161ba. The colored layer 100 is formed above the barrier rib 13 formed between the discharge cells 19.

The sixth embodiment of the present invention is characterized in that curved portions are formed in the front substrate 15, and the bus electrodes 161b are formed in regions where the curved portions are formed. As shown in the drawing, the black layer 161bb is formed along the curved portions of the front substrate 15. The white layer 161ba is additionally formed on the black layer 161bb. Similarly to the bus electrode 161b, the colored layers 100 are also formed in regions where the curved portions of the front substrate 15 are formed. The curved portions are formed in the shape of depressions or protrusions.

In this embodiment of the present invention, the contact area between the black layer 161bb and the front substrate 15 increases. Thus, there is an advantage in that the structure of the black layer and the front substrate is strengthened.

The colored layer 100 is made of the same material as the black layer 161bb of the bus electrode 161b. That is, the colored layer 100 contains ruthenium (Ru), cobalt (Co), or manganese (Mn). Hence, the colored layer 100 has a dark color, i.e., close to black, that increases the black area of the panel, and improves the bright room contrast. The colored layer 100 may be formed on a non-discharge area, for example, an upper surface of the barrier rib 13, so as not to adversely affect the discharge efficiency.

As shown in FIGS. 11A to 11D as examples, various shapes of depressions 110, 112, 114, and 116 can be formed in the front substrate 15. Referring to FIG. 11A, the half-ellipsoidal depressions 110 and the hemispherical depressions 112 are formed in the front substrate 15. The bus electrode 161b is formed along the half-ellispoidal depressions 110. The colored layer 100 is formed along the hemispherical depressions 112.

Referring to FIG. 11B, the bus electrode 161b is formed on one side of the hemispherical depressions 112. The colored layer 100 is formed on the other side of the hemispherical depressions 112.

Referring to FIG. 11C, cuboid depressions 114 are formed in the front substrate 15. The bus electrode 161b and the colored layer 110 are formed on a region where the cuboid depressions 114 are formed.

Referring to FIG. 11D, rhomboid depressions 116 are formed in the front substrate 15. The bus electrode 161b and the colored layer 110 are formed on a region where the rhomboid depressions 116 are formed.

It should be noted that FIGS. 11A through 11D show different shapes only for depressions and only this embodiment in which the black layers of the bus electrodes are disposed in the front substrate. However, the depressions and protrusions in the embodiment comprising a bus electrode with the depressions or protrusions disposed in the transparent electrodes (FIGS. 4, 8 and 9) can also have varying shapes. In both embodiments, and for depressions and protrusions, the shapes can be hemispheres, half-ellipsoids, cuboids, rhomboids, and pyramids, but are not limited thereto.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel comprising:
a front substrate and a rear substrate facing each other at a distance;
a plurality of address electrodes which are formed on the rear substrate and extend in a first direction;
a plurality of display electrodes which are formed on the front substrate and extend in a second direction crossing the first direction;
a barrier rib which is disposed between the front and rear substrates to define a plurality of discharge cells; and
a phosphor layer which is formed in each of the discharge cells,
wherein each display electrode comprises:
a transparent electrode which has a plurality of curved portions on a second surface that is an opposite surface of a first surface facing the front substrate, and
a bus electrode which is attached to the second surface of a respective one of the transparent electrodes where the curved portions are formed.

2. The plasma display panel of claim 1, wherein each bus electrode comprises:
a black layer in contact with the second surface of the transparent electrode; and
a white layer formed on the black layer.

3. The plasma display panel of claim 2, wherein the black layers include one or more metals selected from the group consisting of ruthenium (Ru), cobalt (Co), and manganese (Mn).

4. The plasma display panel of claim 2, wherein the white layers include one or more metals selected from the group consisting of silver (Ag), gold (Au), and aluminum (Al).

5. The plasma display panel of claim 1, wherein the curved portions of the transparent electrodes are formed in the shape of depressions.

6. The plasma display panel of claim 5, wherein each depression has a hemispheric cross-section.

7. The plasma display panel of claim 5, wherein the depressions are constructed with long channels adjacent to one another in one direction.

8. The plasma display panel of claim 5, wherein a part of the bus electrode is inserted into the depressions.

9. The plasma display panel of claim 1, wherein the curved portions of the transparent electrodes are formed in protrusion shapes.

10. The plasma display panel of claim 5, wherein the depressions consist of one or more shapes selected from the group of hemispheres, half-ellipsoids, cuboids, rhomboids and pyramids.

11. The plasma display panel of claim 5, wherein the depressions are arranged in patterns consisting of shapes selected from rectangular grids and zigzags.

12. The plasma display panel of claim 9, wherein the protrusions consist of one or shapes selected from the group of hemispheres, half-ellipsoids, cuboids, rhomboids and pyramids.

13. The plasma display panel of claim 9, wherein the protrusions are arranged in patterns consisting of shapes selected from rectangular grids and zigzags.

14. A plasma display panel comprising
a rear substrate;
a front substrate which faces the rear substrate at a distance and in which curved portions are formed on a surface thereof facing the rear substrate;
a plurality of address electrodes which are formed on the rear substrate and extend in a first direction;
a plurality of bus electrodes which are formed on the front substrate along a region where the curved portions are formed and which extend in a second direction crossing the first direction;
a barrier rib which is disposed between the front and rear substrates to define a plurality of discharge cells; and
a phosphor layer which is formed in each of the discharge cells.

15. The plasma display panel of claim 14, wherein each bus electrode comprises:
a black layer in contact with a surface where the curved portions of the front substrate are formed; and
a white layer formed on the black layer.

16. The plasma display panel of claim 14, further comprising a plurality of colored layers which are formed along the regions where the curved portions are formed and are spaced apart from the bus electrodes.

17. The plasma display panel of claim 14, wherein the curved portions of the front substrate are formed in the shape of depressions

18. The plasma display panel of claim 14, wherein the curved portions of the front substrate are formed in protrusion shapes.

19. The plasma display panel of claim 16, wherein the colored layers include the same material as the black layer.

20. The plasma display panel of claim 16, wherein the colored layers include one or more metals selected from the group consisting of ruthenium (Ru), cobalt (Co), and manganese (Mn).
